(19) United States
(12) Patent Application Publication
(10) Pub. No.: US 2008/0231707 A1
(43) Pub. Date: Sep. 25, 2008

(54) Mobile security tower

(76) Inventor: Duane T. Fontana, Troy, IL (US)

Correspondence Address: DON W. WEBER, 235 BRISTOL, TROY, IL, 62294, US

(21) Appl. No.: 11/725,234

(22) Filed: Mar. 19, 2007

(51) Int. Cl. H04N 7/18

(52) U.S. Cl. 348/158; 348/E05.001

(57) ABSTRACT

A mobile security apparatus has a concrete base with a tall tower pole imbedded in the base. The concrete base is hollow and contains electronic equipment. The base and tower are towed horizontally on a trailer. The trailer has a slidable inner carriage. A push up ladder is connected to the tow vehicle with a pineal hitch on one end and connected to the tower pole by a pivot pin on the other end. When the brakes on the trailer are locked and the vehicle backed up, the base and tower pole are raised to the vertical, deployed position. An array of electronic security devices such as cameras and alarms are then attached to the top of the tower pole. An Ethernet connection at the top of the pole connects the security apparatus to the Internet. Highly mobile camouflaged security containers with motion, tilt and lifting sensors and a wireless link to the security tower can also be placed at strategic locations throughout the protected site.

### BACKGROUND OF THE INVENTION

This invention relates to the field of security. In particular, a mobile security tower with night vision cameras, alarms and an Ethernet connection is presented. Additionally, mobile deployable security containers are available to further secure the site to be protected.

The field of security for airports, office buildings, job sites and the like has been the subject of extensive innovation in the last decade. The need to guard against intruders and to protect property often requires sophisticated electronic surveillance such as night vision camera, remote operation and/or monitoring of the electronic devices and alarms and other innovative techniques. One drawback in using these electronic devices is that artful intruders may disable them. It is an object of this invention to provide a sophisticated electronic security apparatus that is virtually impregnable to outside attack.

Tall security towers are often deployed to guard job sites, parking lots, construction sites, public events or similar locations. These towers are highly effective for security purposes but may frequently be utilized on a temporary basis only. When the construction is complete or the event finished the need for these expensive security towers is also completed. However, deploying and then removing these sophisticated security towers can be quite expensive and time consuming. It is another object of this invention to provide a highly mobile and deployable temporary security tower.

Security towers have the advantage of placing the security monitoring devices such as license plate cameras, night cameras, alarms and sirens high above the ground. The height of the devices is a deterrent to tampering. However, often the recorders or controls for the security devices are located on the ground in vulnerable locations such as offices or guard shacks. Cables for the devices are also accessible. It a still further object of this invention to provide a highly mobile and easily deployable security tower that also protects the recorders, controls and cables from tampering by an intruder.

Particularly on job or construction sites, it would be desirable to locate security monitors or other devices to specifically guard certain equipment, tools or construction materials. The use of cameras is one way to guard these smaller objects. Another effective way to guard smaller objects or acres would be to use some type of small, mobile security container that could sense motion or movement of the container and send a signal to the security tower. It is yet another object of this invention to provide small, inconspicuous, relatively inexpensive tamper proof containers to provide added security to specific materials or objects at a job site.

Other and further objects of this invention will become obvious upon reading the below described specification.

### BRIEF DESCRIPTION OF THE DEVICE

A highly mobile and deployable yet tamper proof security apparatus has a concrete base and a tall tower. The base and tower may be placed horizontally on a trailer and towed to the security site by a vehicle. A pintle type hitch is used for towing. The trailer has an inner, slidable carriage and is connected to the vehicle by a push up ladder. The ladder is also pivotably connected to the tower. When the brakes of the trailer are applied and the vehicle backed up, the concrete base and tall tower slide backwards on the carriage. The base and tower are then forced into the vertical position and may be deployed onto the ground. A wide array of security cameras, alarms, sirens, receivers and an Ethernet connection are connected to the top of the tower. Internal controls and recorders are located in the secure, tamper proof concrete base. Camouflaged highly mobile security containers may also be deployed on equipment or materials and send a radio alarm signal to the tower when tampering occurs. The entire apparatus may be controlled from remote locations by the Ethernet radio link.

### BRIEF DESCRIPTION OF THE DRAWING FIGURES

FIG. 1 is a side view of the tower base, pole, trailer and pushup bar in the towing position.

FIG. 2 is a top view of the pushup bar.

FIG. 2A is a side view of the push up bar.

FIG. 3 is a top view of the slide/slip trailer.

FIG. 3A is a side view of the trailer frame showing the slidable carriage.

FIG. 3B is a side view of the trailer.

FIG. 4 is a side view of the device shown in the half-deployed position.

FIG. 5 is a top view of the short tow bar.

FIG. 5A is a side view of the short tow bar.

FIG. 6 is a side view of the unit with the security devices attached, in the fully deployed position.

FIG. 6A is a side view of the shoulders secured to the frame of the vault door.

### DETAILED DESCRIPTION OF THE PREFERRED EMBODIMENT

A highly mobile and quickly and easily deployable security tower has a concrete base 1 that is generally rectangular in cross-section. The base 1 is hollowed out to receive electronic security equipment. The concrete base 1 has reinforced u-bars embedded into the top of the base for transportation and lifting.

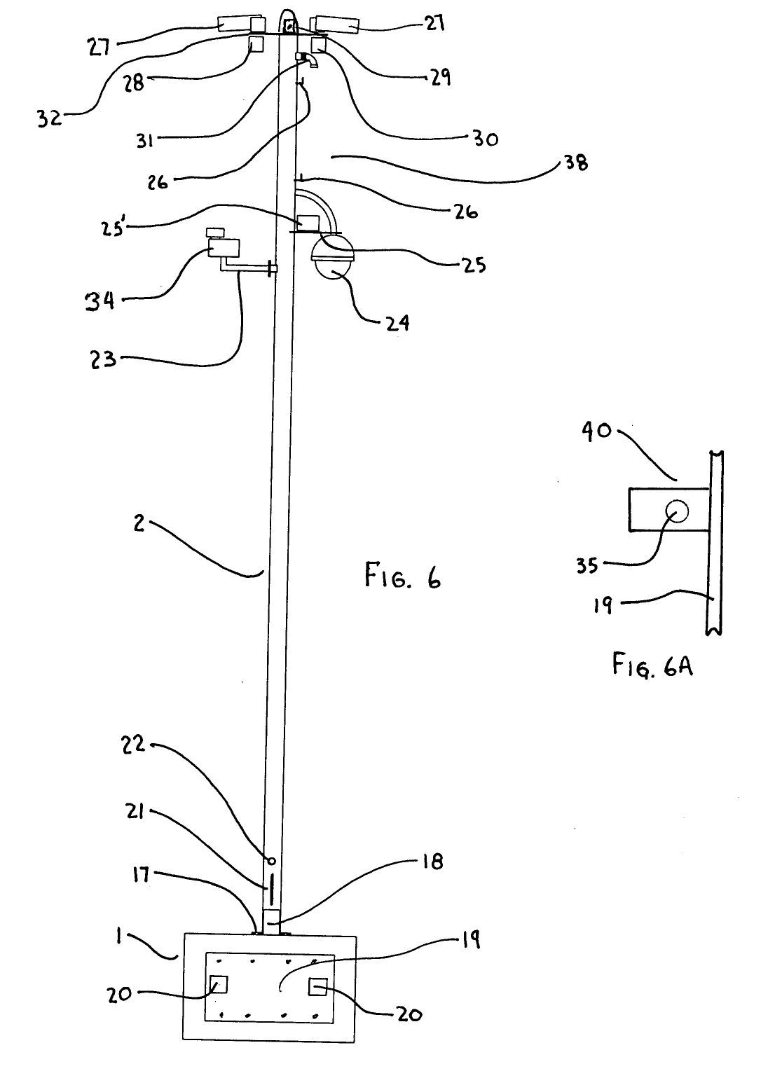

In the preferred embodiment, the concrete base 1 has a cross-section of forty-eight inches and is thirty-two inches tall. The concrete base 1 has inner stability plates (not shown) that are set in the base when the concrete is poured. These horizontal plates are approximately eighteen inches square. An inner pipe 18, as best shown on FIG. 6, is attached to the inner stability plates and protrudes out of the concrete base 1 about eighteen inches. This inner pipe 18 slides into the lower end of the main tower pole 2. This inner pole provides added security since the outer security pole 2 cannot tip or fall, even if the tower pole 2 is unbolted at its lower flange base. The inner/outer pole combination also prevents rain or other fluids from entry at the tower pole base.

The outer tower pole 2 is approximately twenty-one feet tall and is secured to the concrete base 1 by a lower flange 17. The preferred tower pole has an outside diameter of 5.5 inches and is made of steel. The tower pole 2 is hollow to accommodate wiring from the inner hollow base devices to the upper security devices to be described later. The lower flange 17 is permanently secured to the lower end of tower pole 2 and to the concrete base 1 by four bolts. Typically, this flange is made of twelve inch by twelve inch by three-quarter inch steel.

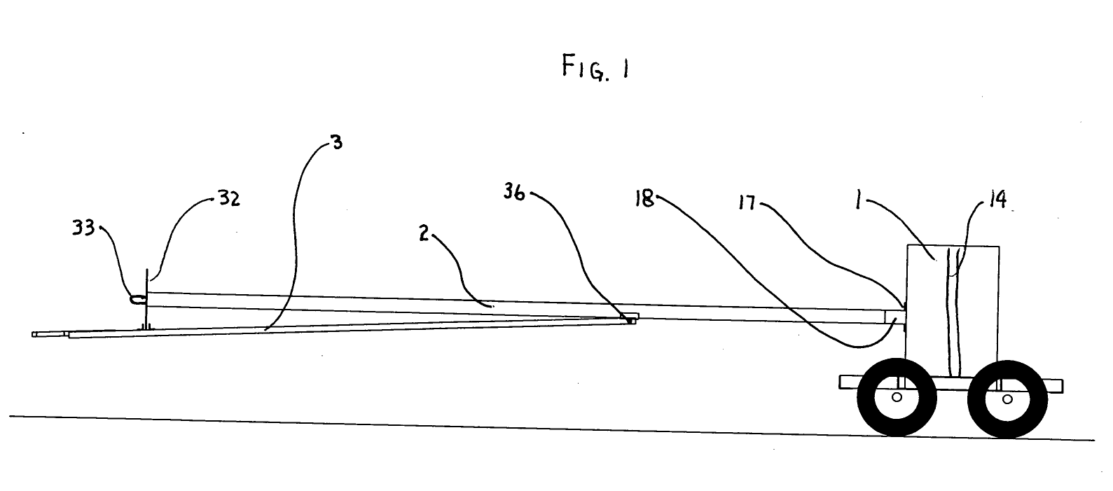

As best shown on FIG. 1, the concrete base 1 rides on a slip/slide trailer 6 when it is being transported. The tower pole 2 is attached to the base 1 and is towed in an essentially horizontal orientation as shown. Fixedly attached to the top of the tower pole 2 is a top plate 32. This top plate 32 rides between ladder bar flanges 5 and 5′.

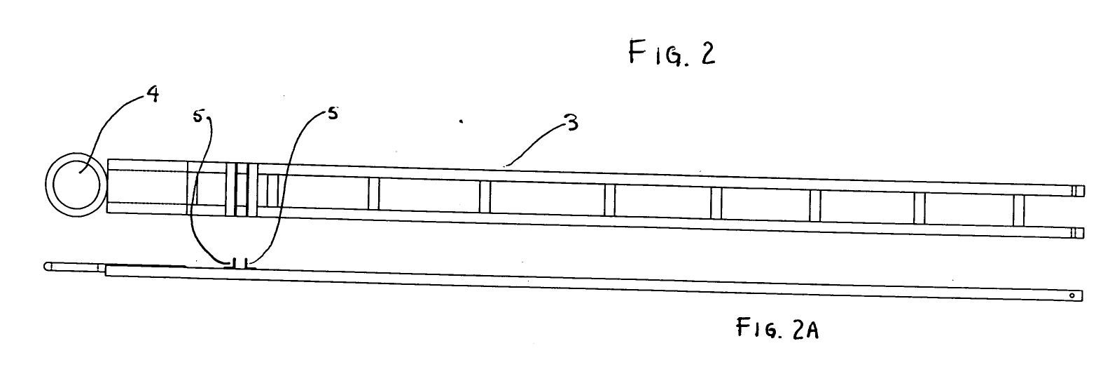

Pivotably attached to the tower pole 2 approximately eighty-two inches from the bottom of the tower pole is a first end of the pushup ladder bar 3. The ladder bar 3 is best shown in FIGS. 2 and 2A. The ladder bar 3 has a pintle loop connector hitch 4 at a second end 39. The pintle loop hitch connector 4 is coupled to the tow vehicle claw. It is important that this type of hitch be used rather than the standard ball type hitch. The pintle loop and claw type hitch allows the easy deployment of the unit, as will be described later. Safety chains, brake connections and lighting are provided between the trailer and the tow vehicle.

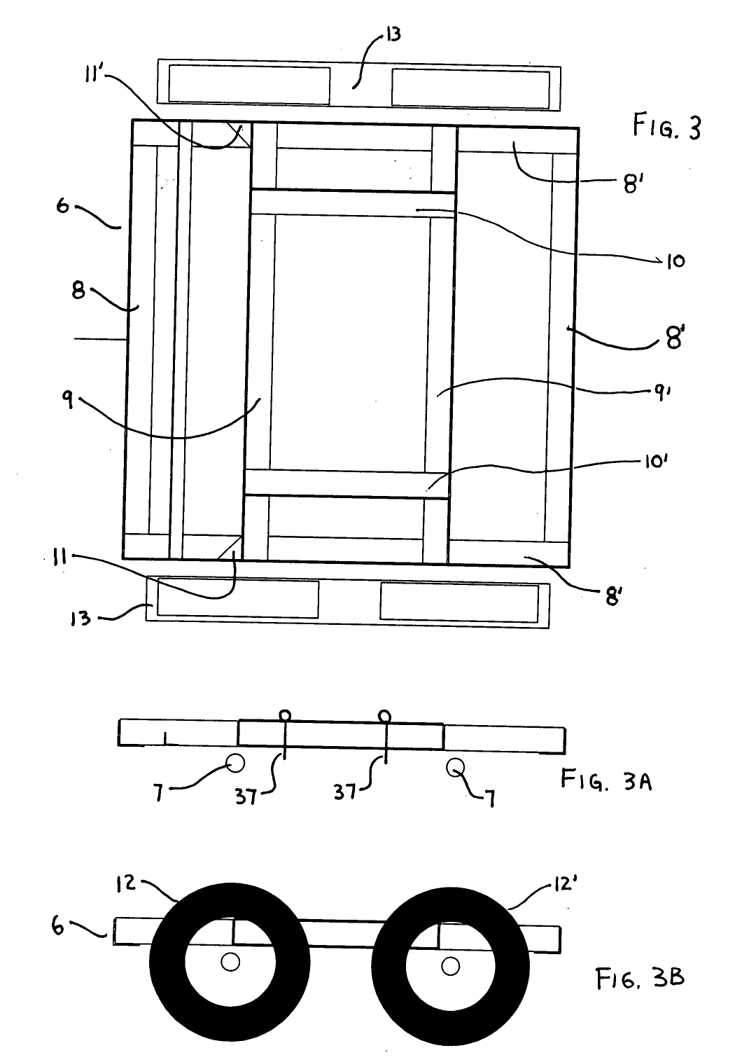

An important aspect of this new invention is the slip/slide trailer 6, as best shown in drawing FIGS. 3, 3A and 3B. The slip/slide trailer 6 is constructed primarily of strong angle iron. The outer perimeter of the trailer has front 8′ and rear, left and right sides 8 fixedly connected together to form an essentially rectangular outer frame. The front rail 8′ is slotted to receive the short tow bar as will be explained later. The trailer 6 has dual axles 7 with front 12 and rear 12′ wheels. The trailer has a brake system that is connected to the tow vehicle.

Inside the outer perimeter frame is a slidable carriage. The carriage is adapted to receive the concrete base 1 for transportation and deployment. The slidable carriage is comprised of front 9 and rear 9′ slidable rails and left 10 and right 10′ fixed rails. The carriage rails are fixedly connected to form an essentially rectangular, slidable carriage. The carriage slides front to back on the frame while deploying and rear to front when retrieving the base and tower. It is important that the heavy base 1 and tower pole 2 ride on the trailer above the axles 7. To insure this correct positioning of the base 1, stops 11 and 11′ are welded to the left and right sides 8 of the frame. These stops keep the base 1 from sliding past the stops. Removable vertical pins 37 connect the carriage and the frame and secure the carriage in place when the trailer is being moved. These pins 37 are removed from the carriage and frame when the carriage is to slide. Fenders 13 cover the tires as in other trailers. When in the transportation mode, a thick securing strap 14 secures the base 1 to the slidable carriage.

Attached to the tower pole 2 approximately eighty-two inches from the base flange is a tower pole pushup pivot bracket 15. This bracket pivotably connects the tower pole 2 and the pushup ladder bar 3. The ladder bar 3 is connected to the tower pole 2 by a pivot pin 36. The connecting pivot pin 36 is typically twelve inches long and is secured in the pivotable position by a cotter pin.

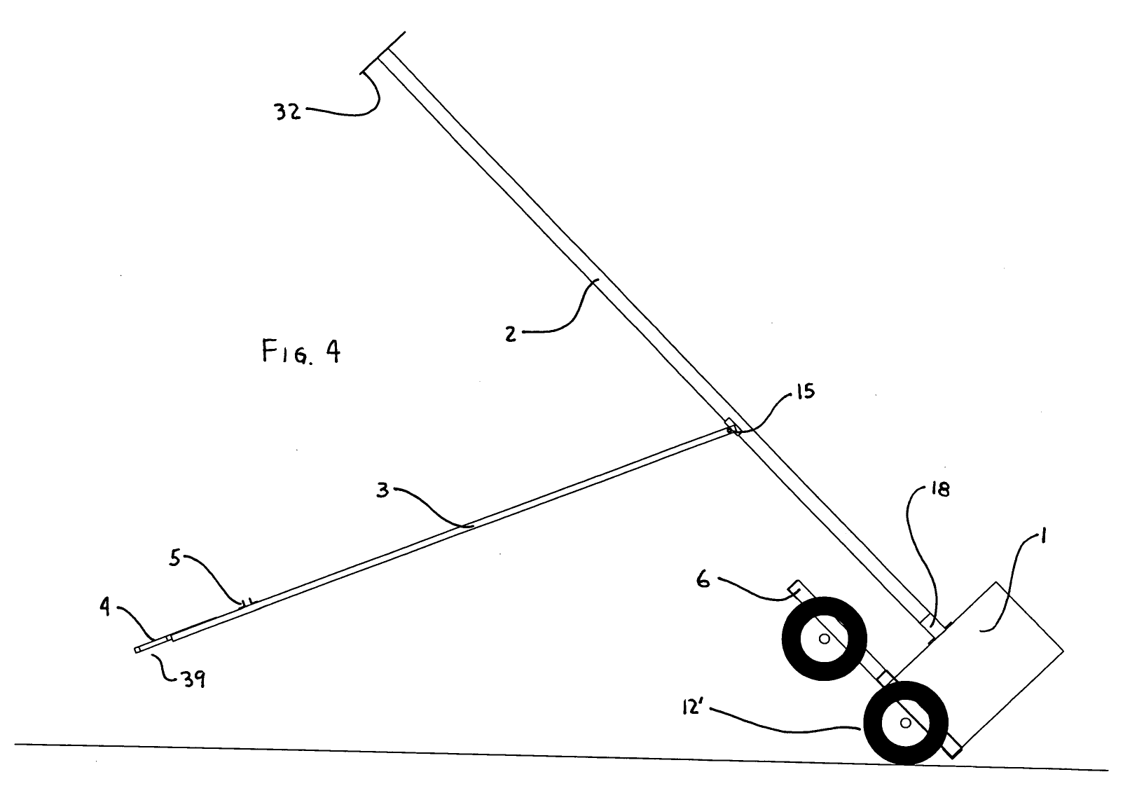

As best shown in FIG. 4, the base 1 and tower pole 2 may be deployed using the tow vehicle and the brakes on the trailer. Vertical deployment of the tower is accomplished by removing the safety strap 14, locking the back wheels with the brake and backing up the tow vehicle. With the brakes on the trailer locked and the unit connected to the tow vehicle by the pintle loop and claw hitch, the backing motion of the vehicle causes the base 1 to slide backwards on the carriage and tower 2 to move vertically, as shown in FIG. 4. Further motion of the vehicle in the backward direction causes the base 1 to slide backwards further and causes the tower pole 2 to become vertical. Once the base 1 slides to the rear of the trailer frame and the tower pole 3 has reaches an essentially vertical position, the concrete base is deployed onto the ground.

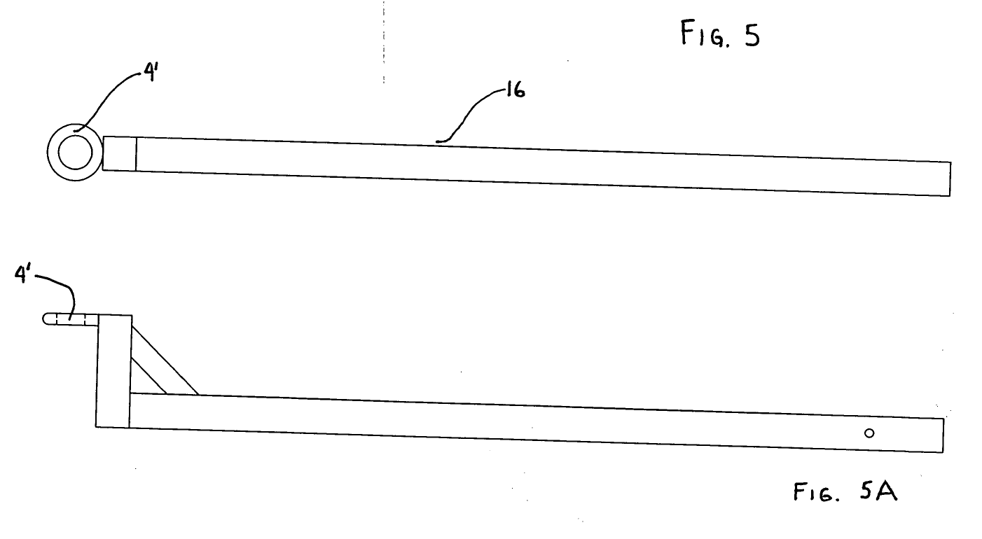

A trailer winch (not shown) is located on the front frame rail 8′. The winch is used to lower the trailer once the trailer has been raised to the vertical by the deployment operation. The pushup ladder is first disconnected from the tower pole. The winch cable is connected to the vehicle. The winch then operates to lower the trailer to the ground for transportation back to the home base. When the trailer has deployed the security base and tower, it may be transported empty using the shorter tow bar 16, as shown in FIGS. 5 and 5A.

Turning now to the security system itself, a variety of security cameras, electronic interfaces, recorders and other security devices may be deployed in practicing this invention. The concrete base 1 has a hollow area adapted to receive the electronic devices common in the security industry. Located inside the base 1 is a variety of security apparatus, including audio and video recording devices, internet interfacing devices, power sources, back-up batteries and other devices. The listing herein is meant as an illustration only and not as a limitation. Obviously, any number and type of devices may be placed in the base.

The inner hollow area of base 1 may be accessed through vault door 19. Embedded into one side of the base 1 is a rectangular steel frame, typically made of strong and secure angle iron. The steel vault door 19 is bolted to the steel embedded frame and is secured to the frame by two shoulders 40 that protrude through slots in the vault door. Typically, the vault door is made of one-quarter inch thick steel. The steel frame is bolted to the concrete block and embedded in it. The frame is recessed for weatherization and security. The recessed frame also prevents an intruder from prying the frame or the locks. Padlocks on the outside of the vault door may be placed through holes 35 located in the shoulders to secure the shoulders. These padlocks are protected from tampering and from the elements by permanently affixed steel padlock covers 20. The only way to remove the vault door and gain access to the security devices inside the base 1 is to remove the eight vault door bolts and padlocks. Removal of the vault door and padlocks is practically impossible even for the most determined and well-equipped intruder.

A weatherized lower security keypad 21 is located at the lower end of the tower pole, as best shown in FIG. 6. This security keypad 21 is used to arm/disarm the security function of the tower and to arm/disarm the security buckets (to be described later). A keypad camera 22 is placed near the keypad to monitor access to the keypad.

Located approximately seventy-six inches from the very top of the tower pole 2 is mounting plate 23. This mounting plate 23 is permanently attached to the tower pole 2 by welding or any other convenient means.

The electronic cameras, Ethernet connections, sirens and other devices are attached to the top seventy-six inches of the pole 2 once the unit is in the vertical, deployed position. This upper part 38 of the tower pole 2 is similar to a “Christmas tree.” The upper part 38, once fully configured, has brackets, cameras and other security devices attached to it. The security devices such as cameras or alarm lights are similar to Christmas tree ornaments hung on a Christmas tree and are variable.

This upper part 38 of pole 2 is approximately six feet tall. The security devices described herein are normally attached to the upper part 38 of pole 2 both mechanically and electrically. The entire length of tower pole 2 is hollow about its longitudinal axis. This allows for wiring between the inner part of the base 1 and the upper surveillance units. Suitable electrical connectors located in the upper part 38 of the tower pole 2 connect the various electrical components.

Typically, support plate 23 is attached to the tower pole 2 at about the 176-inch vertical position from the base 1. This plate 23 supports a license plate camera 34 as shown in FIG. 6. A PTZ dome camera 24, which monitors a 360-degree area around the security pole, may also be attached to the upper part 38 of tower pole 2. The dome camera will typically be mounted with a quick-release mounting union.

A second mounting plate 25 may be fixedly attached to the upper part 38 of tower pole 2 for supporting an alarm/flash bar apparatus 25′ as shown in FIG. 6 Sign brackets 26 may also be attached to the pole to support signage as desired.

Four night vision cameras 27 may be affixed to the very top of pole 2 for monitoring construction or other sites. These cameras are typically mounted to the twenty-four inch by twenty-four inch plate 32 in four different directions for complete coverage of the protected site. A security receiver and controls 28 and an Ethernet connection radio link 30 may also be secured to the top of tower pole 2 as shown. A security siren 29 may be secured to the top of the pole. A removable drip loop external pipe 31 allows for an external power source, such as an extension cord, to power the electronics of the entire unit. The electronic devices in the base 1 may be connected to the cameras and other devices on the top of the tower pole by wires fed from the base through the hollow tower pipe 2 to the top of the pole.

A steel pick up loop 33 tops the pole for ease of handling.

An added feature of this security unit is the mobile container security devices. These container devices (not shown), such as bucket devices, are equipped electronically to sense motion, tilting, infrared, vibrations and/or lifting. The mobile containers are designed to look like items usually found at job or security sites, such as standard buckets found at job sites for holding concrete, plaster or the like. Alternatively, these buckets can be made to look like tool boxes, tools or any other type of item found at the job site or secure area. A bucket tamper siren located inside the unit is utilized to alert the security monitor that the device is being opened, lifted, moved or tilted.

The buckets or containers are sealed for environmental and temperature protection. The typical mobile container contains a battery that can operate the device for up to one year without replacement. A standard replacement battery is used.

A radio transmission from the mobile security container to the tower receiver 28 alarms the security unit of an intruder or thief. This alarm may activate the security light bar, digital dialer, siren and any other auxiliary outputs desired. A tamper switch is built in to the security bucket to notify the monitoring station if the bucket sensors are tampered or if the battery of the security bucket is low.

The security containers may be deployed at the job or other security site at strategic locations to secure the area. For example, containers may be placed on building materials, tools, cooper reels, valuable parts or computers. They may also be placed at strategic locations to insure that the job site or secure area is not entered without detection once the alarms have been set.

The entire security unit, including the secure base 1, tower pole 2, security cameras, keypads, recorders, sirens, alarm, lights, and mobile security containers may be monitored by computer from remote locations by the internet wireless Ethernet connections. The Ethernet wireless connection, located at the top of the pole, can send radio signals to a computer monitor located inside a guard shack, construction trailer or office building. Once connected to the primary internet terminal, the devices may be controlled from any location having an internet connection. Security cameras can be positioned or repositioned from a long distance, alarms can be sounded, dial-up warnings can be given and recordings started or stopped.

The tower is virtually impregnable to assault by even the most determined and well-equipped intruder. The Ethernet connection and the power cord are located at the top of the tower, some twenty-five or thirty feet from the ground. The steel vault doors are attached to an embedded steel frame and redundant locks with protective covers are provided. A visual camera protects the arming keypad. The mobile containers have tamperproof features to alert the monitor if tampering or movement of the containers is attempted.

The security unit has a number of independent now and novel aspects. Additionally, the comprehensive security unit and method of deployment are unique to the security industry.

Having fully described my invention, I claim:

1: A mobile security apparatus capable of being towed by a vehicle, comprising:
(a) a secure, hollow base having electronic equipment located inside said base;
(b) a hollow tower pole, fixedly connected to said base;
(c) a trailer having a slidable inner carriage for supporting said base and tower for transportation to a deployment site;
(d) a push up ladder having one end pivotably connected to said tower pole and a second end connected to a pineal hitch on said tow vehicle.
(e) electronic security devices removably connected to said tower pole.

2: A mobile security apparatus capable of being towed by a vehicle, as in claim 1, further comprising a wireless Ethernet connection attached to the top of said tower pole.

3: A mobile security apparatus capable of being towed by a vehicle, as in claim 1, said hollow base having a tamper proof vault door secured to said base by bolts and locks.

4: A mobile security apparatus capable of being towed by a vehicle, as in claim 1, wherein said electronic equipment in the base is electrically connected to said electronic security devices on the top of said pole through wires in said tower pole.

5: A method of towing and deploying the mobile security tower of claim 1, said method comprising:
(a) locking the brakes of said trailer;
(b) backing up said vehicle until said base and tower are in the vertical position;
(c) pulling said trailer away from said base and tower.

6: A highly mobile, camouflaged security container having motion, tilt and lifting sensors and a power source and a sending device therein wirelessly connected to a security tower.
